(19) United States
(12) Patent Application Publication
(10) Pub. No.: US 2018/0073208 A1
(43) Pub. Date: Mar. 15, 2018

(54) Automated Method to Determine Haul Road Repair Need

(71) Applicant: Caterpillar Inc., Peoria, IL (US)

(72) Inventors: Jeremy J. Wilson, Peoria, IL (US); Tyler Davis, Dunlap, IL (US)

(73) Assignee: Caterpillar Inc., Peoria, IL (US)

(21) Appl. No.: 15/265,543

(22) Filed: Sep. 14, 2016

(51) Int. Cl. E01F 11/00; E02F 9/20; E01C 19/00; E01C 23/00; E01C 11/00; E02F 9/22; G01C 21/26

(52) U.S. Cl. CPC E01F 11/00; E02F 9/2045; E02F 9/2054; E01C 19/004; G01C 21/26; E01C 11/005; E02F 9/2253; E02F 9/22; E01C 23/00

(57) ABSTRACT

Operational data from vehicles operating over a haul road at a work site may be used to determine when road conditions exist that require maintenance to be performed on the haul road. As the vehicles travel over the haul road, sensors transmit sensor signals with the operational data for locations along the road. An electronic control module (ECM) of each vehicle determines road quality indicators for the locations and compares the road quality indicators to predetermined road quality indicator limits. When two or more vehicles determine that a road quality indicator at a location is outside the predetermined road quality indicator limits, or if the same vehicle determines that a road quality indicator at the location is outside the predetermined road quality indicator limits, a road maintenance request message may be generated that will result in the necessary maintenance to be performed at the location.

### TECHNICAL FIELD

The present invention relates generally to vehicles, and more particularly, to an automated method for determining when repairs are needed to a haul road over which the vehicles travel.

### BACKGROUND

Mining and large scale excavating operations require fleets of haul vehicles to transport excavated material such as ore or overburden from an area of excavation over roads to a predetermined destination. For such an operation to be efficient and profitable, the fleet of haul vehicles must be efficiently operated. Efficient operation of these vehicles is affected by the quality of the roads over which they travel. For example, the grade and character of the roads in combination with the size of vehicle payload have direct effects on cycle time, vehicle health, and fuel usage which, in turn, directly affect productivity and profitability of the mining and excavating operations. Over time, haul vehicles have developed from haul trucks capable of moving 20 tons of material to haul trucks that transport more than 350 tons. Increasing payload sizes exert large stresses on the roads over which the haul vehicles operate. Large stresses on the roads increase the propensity of damage to the roads and the haul trucks that operate on them.

Traditionally, maintenance of the roads at a mining or excavating site has been highly reactive. That is, the road defects are repaired as they occur, with little planning or scheduling of repair events. This ad-hoc road maintenance approach is inefficient and increases costs by over or under maintenance of the roads. For example, in some instances damage on a stretch of the road is allowed to accrue until reaching a point when travel along the road becomes dangerous. Repair at this stage is expensive, both in terms of lost productivity and inability to schedule the machines and labor required for the repair at an opportune time. In other instances, a preventive maintenance schedule is followed without regard to the effect of the damage on the operation of the mine. In this case, too much money and effort may be spent on unnecessary road maintenance. As the trend of increasing payload size continues, a holistic approach to manage the maintenance of haul roads is desired to keep operational costs down.

One approach at improving road conditions is disclosed in U.S. Pat. No. 8,145,513 issued to Villalobos et al. (the '513 patent) on Mar. 27, 2012, entitled, “Haul Road Maintenance Management System.” In particular, the '513 patent discloses an open pit mine operation having loading machines, haul vehicles and service trucks traveling over road segments of a haul road between excavation sites, processing sites and dump points. The haul vehicles collect haul vehicle diagnostic data and the service trucks collect road condition data. The data is transmitted from the vehicles and trucks to a control system that analyzes the data to perform haul road maintenance management. A road management team may use the results of the control system analysis to prioritize and schedule haul road defect maintenance and issue road maintenance requests.

### SUMMARY OF THE DISCLOSURE

In one aspect of the present disclosure, a vehicle is disclosed. The vehicle may operate at a work site and travel over a haul road of the work site. The vehicle may include a plurality of sensors automatically monitoring various operational data during travel of the vehicle and outputting sensor signals with including the operational data, a global positioning system (GPS) receiver that determines location coordinates indicating a geographic location of the vehicle and outputting GPS signals including with the location coordinates, a communication module, and an electronic control module (ECM). The ECM may have a memory and may be operatively connected to the sensors, the GPS receiver and the communication module. The ECM is programmed to receive the sensor signals from the sensors and the GPS signals from the GPS receiver as the vehicle is operated operating at the work site and driving along the haul road, to calculate a road quality indicator for each of the location coordinates on the haul road, and to compare the road quality indicator for each of the location coordinates on the haul road to a road quality indicator threshold value stored in the memory that establishes road quality indicator limits, with the road quality indicator threshold value being stored in the memory. The ECM may further be programmed to store the location coordinates and the road quality indicator in a road quality indicator log in the memory and transmit, via the communication module, the location coordinates and the road quality indicator to other vehicles at the work site when the road quality indicator, at one of the location coordinates, is outside the road quality indicator limits. The ECM may also be programmed to receive, via from the communication module, the location coordinates and the road quality indicator for the one of the location coordinates from at least one of the other vehicles and store the location coordinates and the road quality indicator in the road quality indicator log, and to determine whether the road quality indicator log contains road quality indicators for the one of the location coordinates from multiple vehicles. Also, the ECM may be programmed to transmit, via the communication module, a road maintenance request message in response to determining that the road quality indicator log contains road quality indicators for the one of the location coordinates from multiple vehicles.

In another aspect of the present disclosure, a method for determining haul road repair needs at location coordinates on a haul road at a work site having vehicles operating at the work site is disclosed. The method may include at each of the vehicles, gathering operational data at the location coordinates on the haul road as the vehicles are operated at the work site and drive along the haul road, at each of the vehicles, calculating a road quality indicator for each of the location coordinates on the haul road, and at each of the vehicles, comparing the road quality indicator for each of the location coordinates on the haul road to a road quality indicator threshold value that establishes road quality indicator limits. The method may further include at each of the vehicles, transmitting the location coordinates and the road quality indicator to the vehicles in response to determining that the road quality indicator at one of the location coordinates is outside the road quality indicator limits, at one of the vehicles, receiving the location coordinates and the road quality indicator for the one of the location coordinates from the vehicles and storing the location coordinates and the road quality indicator in a road quality indicator log, and at the one of the vehicles, transmitting a road maintenance request message in response to determining that multiple of the vehicles have determined that road quality indicators for the one of the location coordinates are outside of the road quality indicator limits.

Additional aspects are defined by the claims of this patent.

### BRIEF DESCRIPTION OF THE DRAWINGS

FIG. 1 is a schematic and diagrammatic illustration of an exemplary work site where road condition monitoring and reporting in accordance with the present disclosure may be implemented;

FIG. 2 is a side view of an exemplary haul vehicle that can operate in the work site of FIG. 1;

FIG. 3 is a schematic view of electrical and control components of the haul vehicle of FIG. 2; and

FIG. 4 is a block diagram of a road condition monitoring and reporting routine in accordance with the present disclosure that may be executed by an electronic control module of the haul vehicle of FIG. 2.

### DETAILED DESCRIPTION

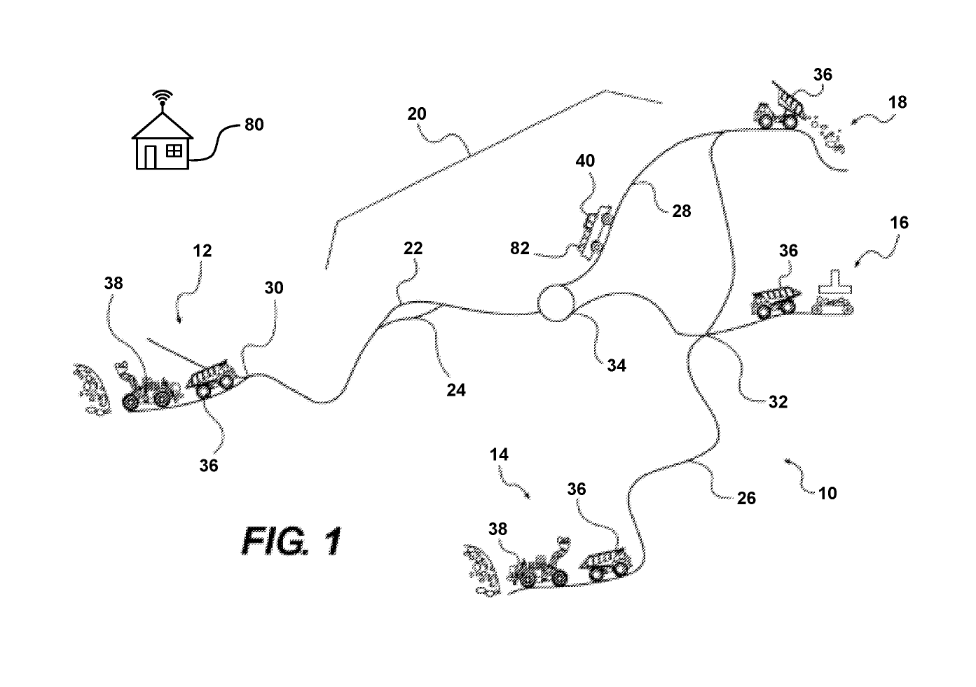

FIG. 1 shows work site 10, such as an open pit mine operation, including a first excavation site 12, a second excavation site 14, a processing site 16, and a dump location 18. The excavation sites 12, 14 may be connected to the processing site 16 and the dump location 18 by a haul road 20. The haul road 20 refers to a network of roads that interconnect different locations within the work site 10. For example, the haul road 20 may include road segments 22, 24, 26, 28. The road segments 22, 24, 26, 28 may be inclined, declined, substantially level, or any combination of these orientations. Haul road intersections such as a “Y” intersection 30, a “+” intersection 32, and a “T” intersection 34 may interconnect the different road segments 22, 24, 26, 28. As part of the mining function, machines and other vehicles may operate at or between different locations of the work site 10. These machines or vehicles may include haul vehicles 36, loading machines 38 and service trucks 40.

The haul vehicle 36 may be any vehicle that may carry excavated materials or other work materials between different locations within the work site 10. Examples of haul vehicles 36 may include articulated trucks, off-highway trucks, on-highway dump trucks, wheel tractor scrapers or any other similar vehicle for hauling material around the work site 10. Loaded haul vehicles 36 may carry overburden from areas of excavation within the excavation sites 12, 14 along the haul road 20 to the dump location 18. The loaded haul vehicles 36 may also carry ore from the excavation sites 12, 14 to the processing site 16 along the haul road 20. Empty haul vehicles 36 may return to the excavation sites 12, 14 along either of these routes.

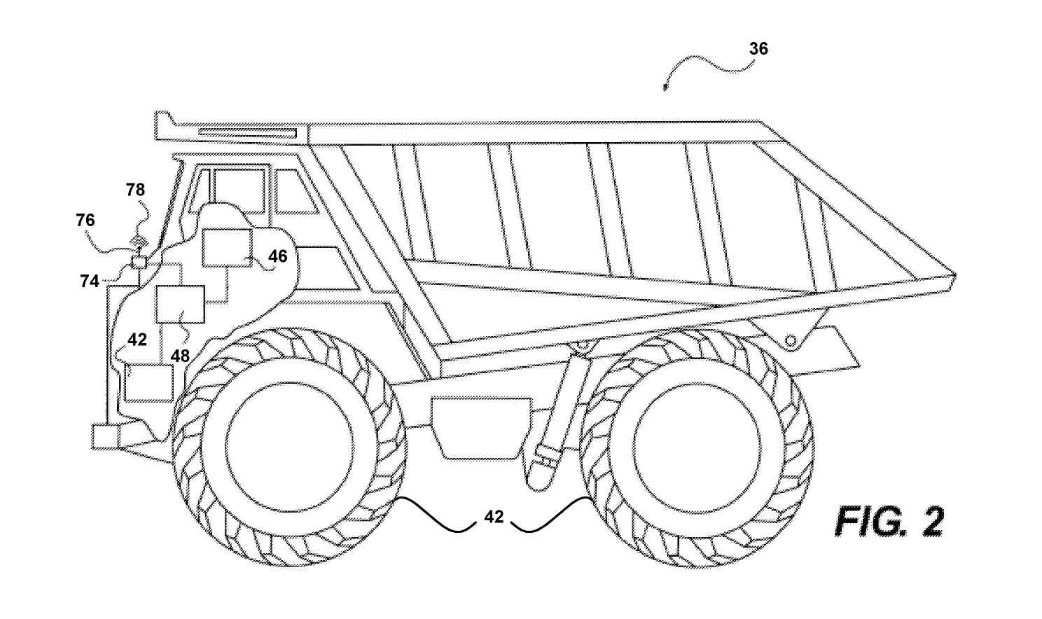

FIG. 2 shows an exemplary haul vehicle 36 in the form of a dump truck that may traverse the haul road 20. The haul vehicle 36 may collect and record operational data relating to the operation of the haul vehicle 36 as it operates within the work site and traverses the haul road 20 either loaded with work material or empty. The collected and recorded operational data may include data automatically acquired from machine sensors and data manually input by an operator of the haul vehicle 36 that can be analyzed and evaluated to determine the condition of the haul road 20 and identify areas of the haul road 20 that may be in need of repair.

The haul vehicle 36 may include a variety of sensors 42 operating independently or as components of other control and monitoring systems to automatically monitor various operational data during travel of the haul vehicle 36 between different locations within the work site 10. The sensors 42 monitoring the operational data may include torque sensors sensing torque at various points along the drive train and/or rolling resistance of traction devices such as wheels 44. The sensors 42 may also include payload weight sensors detecting the weight of a load carried by the haul vehicle 36, sensors on gear shifting mechanisms detecting operator gear selection along the haul route, speed sensors detecting vehicle, engine and transmission speeds, pressure sensors for suspension cylinder and lift cylinder pressures, and the like. The operational data monitored by the sensors 42 may also include road parameters such as, for example, the grade of the haul road 20 measured by inertial measuring units (IMUs), accelerometers or inclinometers, and the location coordinates and elevation of the haul vehicle 36 at a given time as detected by global positioning system (GPS) receivers. Some operational data may be monitored directly, while other data may be derived or calculated from the monitored parameters.

The haul vehicle 36 may also be equipped with an operator data input device 46 for manually recording visually observed operational data. The observed operational data may include information associated with the physical condition of the road segments 22, 24, 26, 28 that an operator of the haul vehicle 36 may observe while driving over the haul road 20 through the work site 10. For example, the observed operational data may include information regarding a defect in one of the road segments 22, 24, 26, 28, such as a type of defect, a severity of the defect, a location of the defect, and any special circumstances that may increase or decrease the impact of the defect on the haul vehicle 36. The type of defects included in the observed operational data may be classified into categories such as pot holes, road surface corrugation, rutting, loose material, poor traction, excessive dustiness, surface cracks and the like. The criticality of the defect may be the operator's impression of the severity of the defect measured on a relative scale used by operators in the work site 10. For instance, the severity of a pot hole defect may be scaled from 1 to 5, with 5 referring to a deep pot hole that may cause immediate damage to the haul vehicle 36, and 1 referring to a pothole that is a mere driving inconvenience at the present time. Upon observing a pothole while traversing the road segments 22, the operator may record the observed operational data on the operator data input device 46. For example, the observed operational data may include “pot hole” as the category of the defect, “2” as the severity of the defect, and “road segment 22” as the location of the defect. Alternatively or additionally, the location of the defect may also be the GPS location of the haul vehicle 36 at the time the defect was observed.

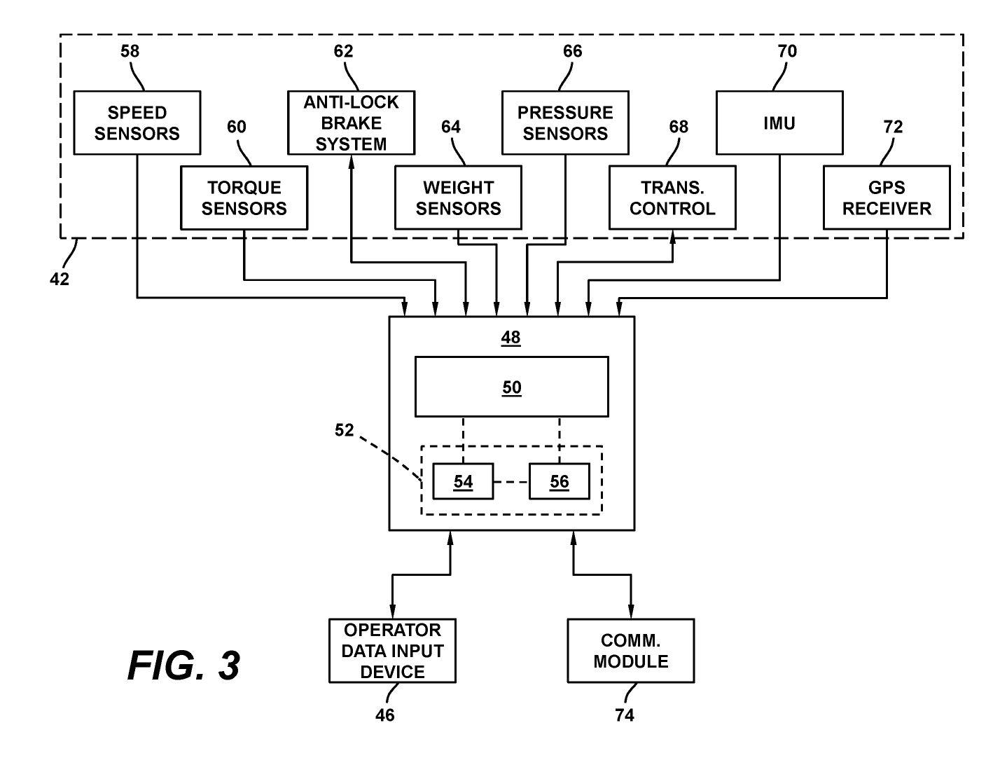

The sensors 42 and the operator data input device 46 may be components of a vehicle control system for the haul vehicle 36. Referring to FIG. 3, the haul vehicle 36 may include various control components that are integrated into the vehicle control system. The haul vehicle 36 may include an electronic control module (ECM) 48 capable of receiving information in signals from the sensors 42, the operator data input device 46 and other control devices. Additionally or alternatively, the ECM 48 may be capable of processing the received information using software stored the ECM 48, and outputting information to devices such as actuators, displays and communication devices that cause the haul vehicle 36 to operate and to provide information to an operator of the haul vehicle 36. The ECM 48 may include a microprocessor 50 for executing a specified program, which controls and monitors various functions associated with the haul vehicle 36. The microprocessor 50 may be operatively connected to a memory 52, such as read only memory (ROM) 54, for storing a program, and a random access memory (RAM) 56 which serves as a working memory area for use in executing the program stored in the memory 52. Although the microprocessor 50 is shown, it is also possible and contemplated to use other electronic components such as a microcontroller, an ASIC (application specific integrated circuit) chip, or any other integrated circuit device. While the discussion provide herein relates to the functionality of a road condition monitoring and reporting system, the ECM 48 may be configured to control other aspects of the operation of the haul vehicle 36 such as, for example, engine control, transmission control, steering, dumping loads of material and the like. Moreover, the ECM 48 may refer collectively to multiple control and processing devices across which the functionality of the road condition monitoring and reporting system and other systems of the haul vehicle 36 may be distributed.

The sensors 42 may encompass a variety of sensors and control systems that are configured to collect operational data for the haul vehicle 36, and transmit sensor signals to the ECM 48 that correspond to the measured values of the operational data. In particular, the sensors 42 discussed herein may collect operational data that is useful in evaluating the condition of the haul road 20 and determining whether maintenance is required to ensure that the vehicles 36, 38, 40 have smooth surfaces over which to operate. For example, the sensors 42 may include speed sensors 58 coupled to rotating components of the haul vehicle 36 such as an engine shaft, a transmission output shaft or axles of the wheels 44. The speed sensors 58 transmit speed sensor signals having values corresponding to the rotational speeds of the components with which the speed sensors 58 are associated. Sudden, unexpected changes of the rotational speeds of components may be indicative of a loss of traction due to moisture on the haul road 20 or of damage to a paving surface leaving loose material that can cause the wheels 44 to spin and the haul vehicle 36 to slip.

Torque sensors 60 may be used in addition to or as alternatives to the speed sensors 58 to provide feedback of the operating conditions at the engine shaft, transmission output shaft, axles or other rotating components. The torque sensors 60 may measure the torque on the rotating components and transmit torque sensor signals to the ECM 48 having values corresponding the sensed torque. Similar to unexpected increases in shaft speeds, significant drops in torque on shafts and axles can indicate slippage of the wheels 44 as the haul vehicle 36 travels over the surface of the haul road 20. The speed sensors 58 and the torque sensors 60 may be independent components, or may be integrated into an anti-lock brake system (ABS) 62 implemented in the haul vehicle 36 to control application of brakes of the haul vehicle 36 to prevent skidding. The ABS 62 will utilize speed sensors, torque sensors and other appropriate sensors and data to determine the proper application of the brakes of the haul vehicle 36. The same data or a portion thereof may be utilized by the ECM 48 to determine if the conditions causing the ABS 62 to brake the wheels 44 in a particular manner are related to a maintenance issue with the haul road 20.

The significance and the interpretation of the signals from the speed sensors 58, the torque sensors 60 and the ABS 62 may vary based on the state of loading of the haul vehicle 36. For example, the wheels 44 can slip more easily when the haul vehicle 36 is empty and relatively light than when the haul vehicle 36 is carrying a load of material and is relatively heavy. Consequently, the sensor data from the speed sensors 58, the torque sensors 60 and the ABS 62, an possibly from others of the sensors 42 described herein, should be interpreted differently when the haul vehicle 36 is empty to avoid having false positive determinations of road quality issues when the wheels 44 spin or a drop in torque is detected. In some embodiments, weight sensors 64 may be provided to sense a magnitude of the load in the haul vehicle 36 and transmit weight sensors signals to the ECM 48 having values corresponding to the weight of the load of material. The ECM 48 may then adjust the evaluation of the values of the other operational data accordingly. For example, a sudden increase in speed or decrease in torque on an axle may suggest conditions on the haul road 20 causing the wheels 44 to slip. Such slippage may be more likely to occur when the haul vehicle 36 is empty and lighter than when the haul vehicle 36 is loaded and heavier. Because slippage is less likely for the loaded haul vehicle 36, the ECM 48 may be configured to determine that a speed increase or torque decrease in a loaded haul vehicle 36 indicates a road condition requiring maintenance exists, while determining that the same speed increase or torque decrease for the unloaded haul vehicle 36 does not indicate a road condition requiring maintenance does not exist.

The sensors 42 may further include pressure sensors 66 for sensing fluid pressures in hydraulic cylinders, pneumatic cylinders and the like. Components and actuators have pressures that vary based on the magnitude of the loads borne by the components. Such components and actuators include shock absorbers that support the weight of the haul vehicle 36 and loaded material, and lift and tilt cylinders that operate to control the positions of components such as dump bodies, booms, lift arms, tilt arms and implements. These pressures in the components and actuators can change in predictable ways as the haul vehicle 36 travels over the haul road 20 and experiences changes in its orientation as the grade of the road segments 22, 24, 26, 28 changes from uphill to flat to downhill and vice versa, and tilts from side to side. Site maps for the work site 10 may be stored in the memory 52, and information for the GPS positions along the road segments 22, 24, 26, 28 may be stored in the site maps may include known road grades and tilts that can be used in interpreting pressure changes in pressure sensor signals that are transmitted from the pressure sensors 66 to the ECM 48. Unexpected large pressure variations may occur when the wheels 44 hit pot holes or obstructions in the haul road 20 and create shock loads to the haul vehicles 36. These large pressure variations in the pressure sensors signals present a further alternative source of operational data for identifying road conditions that may require maintenance for safe operation of the haul vehicles 36.

A transmission control 68 that exchanges sensor signals and control signals with the ECM 48 can also provide operational data that may be relevant to evaluating the sensor signals from other sensors 42. The transmission control 68 can provide information such as a gear or drive mode input by an operator of the haul vehicle 36, and engagement statuses of gears and clutches in a transmission of the haul vehicle 36 that indicate a current gear ratio of the transmission and can be used in interpreting the sensor signals from the speed sensors 58 and the torque sensors 60. Data from the transmission control 68 can also be used to identify occurrences of shift hunting in the transmission that are indicative of changes in the road conditions that can cause excessive upshifting and downshifting to maintain the speed of the haul vehicle 36.

As discussed above, direct measurement of the grade or tilt of the haul road 20 may be provided by an IMU 70, accelerometers, inclinometers or other appropriate vehicle orientation sensors. Where grade and tilt information is stored in the site map, measured values of grade and tilt from IMU sensor signals may be compared to the expected values from the site map, with differences in the values indicating potential road condition issues. Alternatively or in addition, instantaneous changes to the grade and/or tilt in the IMU sensor signals may indicate unexpected elevation changes independent of any comparison to the expected values in the site map. In some implementations, it may be desirable to configured the ECM 48 to update the site map with the directly measured tilt and grade data if such information is not already provided, or to maintain the most current information on the condition and contour of the haul road 20.

The location coordinates and elevation of the haul vehicle 36 at a given time may be detected by a GPS receiver 72 that transmits GPS signals to the ECM 48. The location coordinates from the GPS receiver 72 may be used by the ECM 48 to initially determine that the haul vehicle 36 is operating within the work site 10 and travelling along one of the road segments 22, 24, 26, 28 of the haul road 20. If the haul vehicle 36 is operating outside the work site 10, it may not be necessary for the ECM 48 to perform road condition monitoring at that time. If the haul vehicle 36 is within the work site 10, the GPS data can be used to access the site map for any stored data for the location of the haul vehicle 36 along the haul road 20 that may be necessary for comparison to the operational data provided by the other sensors 42. While the GPS receiver 72 is illustrated and described herein for providing location coordinates and elevation data for the haul vehicle 36, those skilled in the art will understand that alternative mechanisms for determining the geographic locations of the haul vehicles 36 may be implemented and are contemplated by the inventors.

The haul vehicle 36 may also have a communication module 74 for communicating with other vehicles 36, 38, 40 at the work site 10, peripheral equipment and computing devices on-site or located at remote locations. The communication module 74 may be operatively connected to the ECM 48 and may include any device or devices that facilitate communication between the haul vehicles 36 and other devices or systems. The communication module 74 may include universal serial bus (USB) ports, serial ports, parallel ports, network ports or other direct connection interfaces. The connection interfaces may be used for connecting external devices to the ECM 48, such as portable computing devices, tablets, laptops and the like or local area networks (LANs), wide area networks (WANs) or other communication networks. The communication module 74 may also include hardware and/or software that enable the communication module 74 to send and/or receive data through a wireless communication link 76 in a data transmission 78 (as shown in FIG. 2). The data transmissions 78 may be exchanged between the plurality of vehicles 36, 38, 40 operating in the work site 10, and with back offices 80 that may be located at the work site 10 or remote from the work site 10 and provide control systems for one or more work sites 10.

The loading machines 38 may be any machines that load materials excavated in the work site 10 onto the haul vehicles 36. Examples of the loading machines 38 may include wheel loaders, front shovels, excavators, electric cable shovels or any other similar machines. The excavated materials may include ore, overburden or any other type of material that may be moved around the work site 10. One or more loading machines 38 may operate within the excavation sites 12, 14 to load the excavated materials or other transported materials onto the haul vehicles 36. The loading machines 38 may be configured in a similar manner as the haul vehicles 36 as described above with an ECM 48, sensors 42 and operator data input device 46 to detect and record operational data that will be used in evaluating the condition of the haul road 20 as the loading machines 38 traverse the road segments 22, 24, 26, 28, and a communication module 74 for communications with other vehicles 36, 38, 40 and base station(s) 80 of the control system.

The service trucks 40, such as on-highway pickup trucks or equipment monitoring vans, may be utilized to carry personnel and/or road monitoring equipment over the haul road 20. The service trucks 40 may be configured with similar devices as the haul vehicles 36 and the loading machines 38 for tracking operational data, and may also be fitted with alternative or additional sensing devices 82 for monitor the condition of the haul road 20. The additional sensing devices 82 could include, for example, high speed profilometers to measure the road surface roughness while traveling over the road segments 22, 24, 26, 28, cameras to capture actual road condition footage, or other visual inspection monitoring devices. As with the haul vehicles 36 and the loading machines 38, the service trucks 40 may include an ECM 48, sensors 42, operator data input devices 46 and communication modules 74 to detect and record operational data that will be used in evaluating the condition of the haul road 20 as the loading machines 38 traverse the road segments 22, 24, 26, 28, and a communication module 74 for communications with other vehicles 36, 38, 40 and base station(s) 80 of the control system.

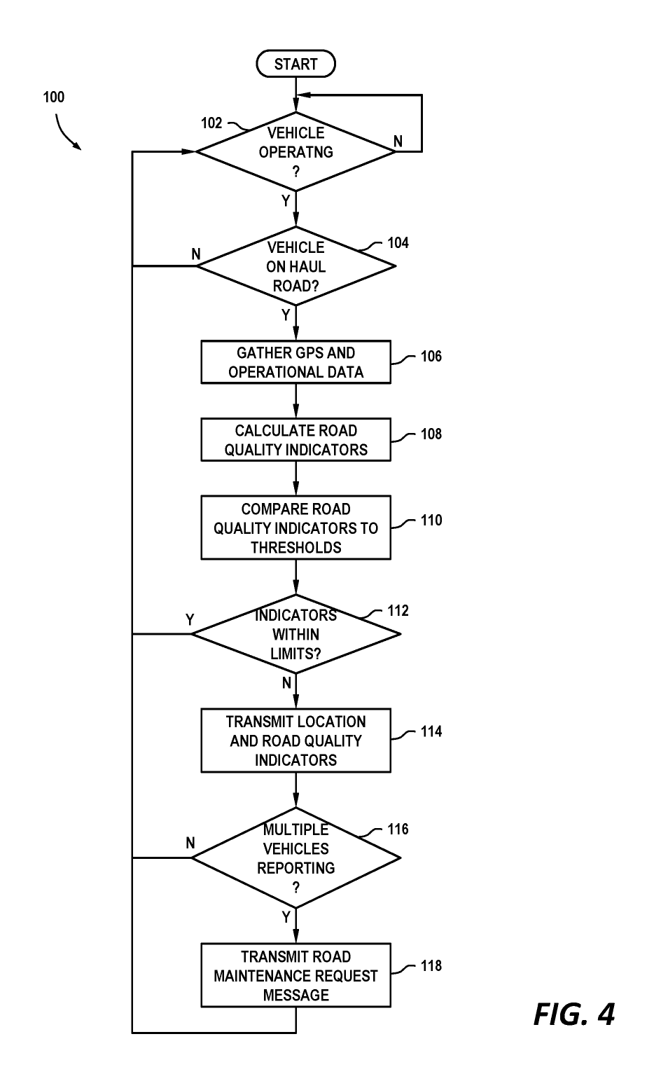

The vehicles 36, 38, 40 are configured to collaboratively monitor the conditions of the haul road 20 and to identify when a location or locations on the road segments 22, 24, 26, 28 are in need of repair. FIG. 4 illustrates a flow diagram for an embodiment of a road condition monitoring and reporting routine 100 that may be stored in the memories 52 and executed by the ECMs 48 of multiple vehicles 36, 38, 40 at the work site 10. Using one of the haul vehicles 36 as an example, the ECM 48 may begin executing the routine 100 when the haul vehicle is started up at a block 102, where the ECM 48 determines whether the haul vehicle 36 is operating. The ECM 48 may evaluate operational data from the sensors 42 to determine if the haul vehicle 36 is performing operations, such as driving or dumping a load of material. In the case of one of the loading machines 38, the ECM 48 may determine whether the loading machine 38 is excavating material or depositing material into one of the haul vehicles 36. Signals from the speed sensors 58, the torque sensors 60 or the transmission control 68 may indicate whether the axles are rotating or the transmission is engaged to drive the haul vehicle 36. Signals from the weight sensors 64 or the pressure sensors 66 may indicate that the haul vehicle 36 is being loaded with material or may indicate that the haul vehicle 36 is dumping a load of material. If the ECM 48 determines that the haul vehicle 36 is not operating, the condition of the haul road 20 cannot be evaluated, and control may pass back to the block 102 until the ECM 48 determines that the haul vehicle 36 is operating.

If the ECM 48 determines that the haul vehicle 36 is operating, control may pass to a block 104 where the ECM 48 may determine whether the haul vehicle 36 is operating on the haul road 20. The ECM 48 may use the sensor signals from the GPS receiver 72 or other geographic location sensor to determine the location coordinates of the haul vehicle 36 using methods known in the art. The location coordinates from the sensor signals may then be compared to location coordinates stored in the site map in the memory 52. If the location coordinates are not found in the site map, the haul vehicle 36 is not on the haul road 20, and the haul vehicle 36 may not even be in the work site 10. This is another situation where the condition of the haul road 20 cannot be evaluated, and control may again pass back to the block 102 for the ECM 48 determine whether the haul vehicle 36 is still operating and then reevaluate the location of the haul vehicle 36 in relation to the haul road 20.

If the location coordinates are found in the site map at the block 104, the haul vehicle 36 is operating on the haul road 20, and the condition of the haul road 20 can be evaluated. Control may pass to a block 106 where the ECM 48 will gather the GPS data from the GPS receiver 72 and corresponding operational data in the sensor signals from the sensors 42 that will be used in the evaluation of the condition of the haul road 20. The ECM 48 may also be programmed to generate a timestamp for the gathered data to distinguish the current data from other instances where the haul vehicle 36 or other vehicles 36, 38, 40 traverse the same location. The gathered location coordinates, the operational data and the timestamp may then be stored in the memory 52 as a precursor to further processing.

With the location coordinates and operational data gathered at the block 106, control may pass to a block 108 where the ECM 48 may calculate road quality indicators for the location on the haul road 20. The ECM 48 may use any appropriate strategy that is known or later developed for using the operational data to determine a road quality indicator value that is indicative of the condition of the location of the haul road 20. For example, U.S. Pat. No. 5,817,936 issued on Oct. 6, 1998, to Schricker discloses a method for calculating a resistance factor that is averaged and trended over time in order to detect a change in the condition of a road. In other examples, a first road quality indicator may be a traction road quality indicator that may be calculated using the vehicle and load weights, road grade, torque and/or speed data and data from the ABS system 62 to determine the traction over the surface of the haul road 20. The traction road quality indicator may have a value similar to a coefficient of friction or a resistance factor of the road surface to the rotation of the wheels 44. In another example, a second road quality indicator such as a surface road quality indicator may be calculated using orientation change data from the IMU 70 and pressure changes at the weight sensors 64 and the pressure sensors 66 to determine a velocity at which the elevation of the haul road 20 is changing. Extreme values of the surface road quality indicator may indicate the existence of a pot hole or an obstruction in the road surface creating shock loads on the haul vehicle 36 that cause rapid changes in the vehicle orientation and large pressure increases or decreases in shock absorbers and hydraulic actuators. In many implementations, the ECM 48 may calculate a plurality of road quality indicators for redundancy or to identify different road conditions that may require maintenance to the haul road 20.

After the ECM 48 calculates the road quality indicators, control may pass to a block 110 to compare the calculated road quality indicators to predetermined thresholds to determine whether a road quality issue exists and maintenance may be necessary. For example, the traction road quality indicator may have an associated traction threshold. If the traction road quality indicator is greater than the traction threshold, the road surface may provide sufficient traction to prevent the wheels 44 from slipping as the haul vehicle 36 travels over the location. Conversely, if the traction road quality indicator is less than the traction threshold, the road surface may allow the wheels 44 to slip as indicated by unexpected increases in the rotational speeds of the axles. The surface road quality indicator may have a lower surface road quality threshold and an upper surface road quality threshold. The threshold quality indicator may be calculated in a manner such that rapid downward movement of a wheel 44 into a pot hole or other void in the haul road yields a smaller surface road quality indicator, and rapid upward movement to move the wheel 44 over an obstruction on the haul road 20 yields a larger surface road quality indicator. With such road quality indicators with upper and lower thresholds, indicator values greater than the upper threshold or less than the lower threshold can be indicative of road conditions requiring maintenance.

After the comparisons, control may pass to a block 112 to determine whether the values of the road quality indicators are within the limits established by the predetermined thresholds. If the road quality indicator values are within the limits established by the thresholds, the road conditions may be acceptable and control may pass back to the block 102 to continue monitoring the operational status of the haul vehicle 36 and evaluating the operational data as the haul vehicle 36 travels over the haul road 20. If the road quality indicator values are outside the limits established by the thresholds, the road conditions may require maintenance and control may pass to a block 114 to transmit the location coordinates and the road quality indicators via the communication module 74 and the wireless communication link 76. The transmitted information may also include the timestamp generated by the ECM 48, a vehicle identifier corresponding to the haul vehicle 36 so that the source of the information can be identified, and any other information necessary for processing the location coordinates and road quality indicators. At the same time, the ECM 48 of the haul vehicle 36 may store the location coordinates and the road quality indicator in a road quality indicator log stored in the memory 52 for future reference in determining whether a road condition requiring maintenance actually exists as discussed below.

In the collaborative strategy of the present disclosure, the transmitted location coordinates and road quality indicators transmitted by the wireless communication link 76 of the haul vehicle 36 may be intended for the other vehicles 36, 38, 40 operating within the work site 10 and to be received at their respective wireless communication links 76. The ECMs 48 may be programmed to discern between messages transmitted by other vehicles 36, 38, 40 within the same work site 10, such as by comparing the location coordinates to predefined geographic boundaries of the work site 10, and messages transmitted from outside the work site 10 and therefore not relevant to the processing of the routine 100. When the messages relating to the road conditions of the work site 10 are received at the vehicles 36, 38, 40, the ECMs 48 may store the information from the messages in the memory 52 in the road quality indicator log. It should be noted that some or all of the other vehicles 36, 38, 40 operating in the work site 10 will be executing the routine 100 as they operate over the haul road 20. Consequently, the vehicles 36, 38, 40 executing the routine 100 will be constantly gathering operational data at locations along the haul road 20, calculating and comparing road quality indicators to thresholds, and transmitting messages to and receiving messages from each other with information regarding the conditions at the locations along the haul road 20.

When the ECM 48 of the haul vehicle 36 causes transmission of a road condition indicator message to other vehicles 36, 38, 40, or receives a road condition indicator message from another one of the vehicles 36, 38, 40, control may pass to a block 116 where the ECM 48 may determine whether multiple vehicles 36, 38, 40 have reported or transmitted road condition indicator messages indicating a road condition potentially requiring maintenance at the same location coordinates along the haul road 20. To ensure that road conditions requiring maintenance do in fact exist, the routine 100 may require that the road condition be determined by multiple vehicles 36, 38, 40 before maintenance is requested. Single instances of detection of road conditions could be false positive determinations of road conditions by one of the vehicles 36, 38, 40, or positive detections of a temporary road condition, such as the presence of an obstruction of the haul road 20 that was pushed off the road by the detecting vehicle 36, 38, 40 or otherwise removed from the path to eliminate the road condition without the need for additional road maintenance. The ECM 48 may search the road quality indicator log stored in the memory 52 for other occurrences of the location coordinates that may have been generated by the ECM 48 or received from other vehicles 36, 38, 40. If the ECM 48 does not find any other road quality indicator entries for the location coordinates in the log, the ECM 48 may determine that the road condition has not been reported multiple times, and control may pass back to the block 102 to continue monitoring for other road conditions. If the ECM 48 finds other road quality indicator entries in the log, control may pass to a block 118 where the ECM 48 may cause a road maintenance request message to be transmitted by the haul vehicle 36 in real time to the back office 80 or to be transmitted by or downloaded from the haul vehicle 36 at a later time as discussed further below.

In various implementations of the routine 100, additional conditions beyond finding road quality indicator entries in the log must be met before the road maintenance request is generated. For example, it may be necessary to verify that at least one road quality indicator message came from a different vehicle 36, 38, 40 than the vehicle 36, 38, 40 that generated the current road quality indicator message. This check may ensure that multiple vehicles 36, 38, 40 detect the road condition and not just one that may be incorrectly processing the operational data and calculating the road quality indicators. Under this scenario, the ECM 48 may be further programmed to generate a road maintenance request message if the search of the log returns some number of road quality indicator messages greater than two that were generated by the same vehicle 36, 38, 40 to ensure that an actual road condition requiring maintenance is not being overlooked.

In some implementations, the ECM 48 may be configured to confirm that the same road condition has been identified by multiple vehicles 36, 38, 40 before transmitting a road maintenance request message. If multiple vehicles 36, 38, 40 transmitted road condition indicator messages for the same location coordinates, but one vehicle 36, 38, 40 transmitted a traction road condition indicator for a wheel 44 slipping and another vehicle 36, 38, 40 transmitted a surface road condition indicator for hitting a pot hole or an obstruction at the same location, the ECM 48 may be configured to defer transmitting a road maintenance request message until another road condition message indicator is generated that confirms whether the actual road condition is relate to slippage or to a pot hole or obstruction. When the subsequent road condition indicator message is generated and causes control to pass to the block 116, the ECM 48 can discern the true nature of the road condition and transmit an appropriate road maintenance request message at the block 118.

The transmission of the road maintenance request message at the block 118 may occur in real time, or may be delayed until another appropriate time based on the particular configuration of the routine 100. In some implementations, the transmission may occur in real time, with the ECM 48 of the haul vehicle 36 transmitting the road maintenance request message to the back office 80 using the communication module 74 and the wireless communication link 76. A single one of the vehicles 36, 38, 40 may be designated as a back office communication vehicle responsible for transmitting the road maintenance request messages for the work site 10, or the routine 100 may be configured so that any of the vehicles 36, 38, 40 determining that road quality indicator messages have been generated by multiple vehicles 36, 38, 40 can transmit a road maintenance request message to the back office 80.

In other system configurations, the ECM 48 of a designated back office communication vehicle may be programmed to queue up road maintenance request messages for transmission at a later time. At the appropriate time, a batch of queued road maintenance request message can be transmitted to the back office 80 via the wireless communication link 76. In other implementations, transmission of the message may occur when an operator, supervisor or maintenance technician connects a peripheral device or establishes a network connection at an appropriate port of the designated back office communication vehicle for downloading the messages to the peripheral device or for transmission of the message over the network to the back office 80. It is also contemplated to utilize multiple data transmission modes within one implementation of the routine 100. For example, the ECM 48 may be configured to differentiate between road conditions requiring immediate attention and road conditions that exist but do not require immediate attention based on the amount by which the road quality indicators are outside the limits established by the thresholds. Road maintenance request messages may be transmitted in real time via the wireless communication link 76 for the severe road conditions, while road maintenance request messages for the less immediate road conditions can be transmitted to the back office 80 at an appropriate time using wireless communications, downloads or network connections as appropriate. After the road maintenance request messages are handle appropriately at the block 118 for the particular configuration of the routine 100, control may pass back to the block 102 to continue monitoring the operational status of the haul vehicle 36 and evaluating the operational data as the haul vehicle 36 travels over the haul road 20.

After the road maintenance request messages are generated and transmitted by the vehicles 36, 38, 40, the road maintenance request messages can be handled in any appropriate manner so that the necessary maintenance is performed on the haul road 20. For example, in one implementation, the road maintenance request messages may be displayed at a terminal at the back office 80 so that a maintenance technician can take the necessary steps to schedule manpower and equipment for making the necessary road repairs at a time that may cause the least disruption to the operations at the work site 10. Alternatively, receipt of a road maintenance request at the back office 80 may cause a back office controller to execute a haul road maintenance routine that automatically generates a work order for performing the necessary road maintenance operations. In other implementations, the back office 80 may be configured to forward the road maintenance request message to a road maintenance vehicle that can perform the necessary road maintenance, such as a road paving machine, and cause the engine of the maintenance vehicle to start and a display device of the maintenance vehicle to display information regarding the needed repair (e.g., the road condition, the location of the road condition, etc.). The maintenance vehicle may be an autonomous vehicle, and receipt of the road maintenance request message may cause the maintenance vehicle to automatically deploy to the location of the road condition and perform the necessary maintenance. Additional strategies for responding to the generated road maintenance request messages are contemplated by the inventors.

### INDUSTRIAL APPLICABILITY

The method for determining haul road repair needs in accordance with the present disclosure utilizes the sensors 42 that may already be present in the vehicles 36, 38, 40 traveling over the haul road 20 to determine when road conditions, that will require maintenance, develop at locations on the haul road 20. Consequently, the method can be implemented by installing software for the routine 100 at the ECMs 48 of some or all of the vehicles 36, 38, 40 that will be operating at the work site 10. Moreover, the vehicles 36, 38, 40 work in the collaborative manner described above to identify road repair needs without the necessity of sending out separate vehicles and operators to manually inspect the segments 22, 24, 26, 28 of the haul road 20 for locations requiring maintenance. The collaboration between the vehicles 36, 38, 40 and requiring multiple detections of a road condition may serve to more accurately identify the road conditions and transmit road maintenance request messages when multiple sources have determined that the road condition requiring maintenance exists. This system facilitates road conditions being identified as they develop so the conditions can be corrected before the vehicles 36, 38, 40 are damaged by the conditions and at times where the maintenance work can be scheduled efficiently and cost effectively.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A vehicle for operating at a work site and traveling over a haul road of the work site, the vehicle comprising:
a plurality of sensors automatically monitoring various operational data during travel of the vehicle and outputting sensor signals including the operational data;
a global positioning system (GPS) receiver that determines location coordinates indicating a geographic location of the vehicle and outputting GPS signals including the location coordinates;
a communication module; and
an electronic control module (ECM) having a memory and operatively connected to the sensors, the GPS receiver and the communication module, wherein the ECM is programmed to:
receive the sensor signals from the sensors and the GPS signals from the GPS receiver as the vehicle is operating at the work site and driving along the haul road,
calculate a road quality indicator for each of the location coordinates on the haul road,
compare the road quality indicator for each of the location coordinates on the haul road to a road quality indicator threshold value that establishes road quality indicator limits, the road quality indicator threshold value being stored in the memory,
store the location coordinates and the road quality indicator in a road quality indicator log in the memory and transmit, via the communication module, the location coordinates and the road quality indicator to other vehicles at the work site when the road quality indicator, at one of the location coordinates, is outside the road quality indicator limits,
receive, via the communication module, the location coordinates and the road quality indicator for the one of the location coordinates from at least one of the other vehicles at the work site and store the location coordinates and the road quality indicator in the road quality indicator log in the memory,
determine whether the road quality indicator log contains road quality indicators for the one of the location coordinates from multiple vehicles, and
transmit, via the communication module, a road maintenance request message in response to determining that the road quality indicator log contains road quality indicators for the one of the location coordinates from multiple vehicles.

2. The vehicle of claim 1, wherein the ECM is programmed to transmit the location coordinates and the road quality indicator from the communication module via a wireless communication link.

3. The vehicle of claim 1, wherein the ECM is programmed to transmit the road maintenance request message in response to determining that one of the vehicles has determined more than two times that the road quality indicators for the one of the location coordinates are outside of the road quality indicator limits.

4. The vehicle of claim 1, wherein the road quality indicator comprises a first road quality indicator and a second road quality indicator, and wherein the ECM is programmed to:
calculate the first road quality indicator and the second road quality indicator for each of the location coordinates on the haul road;
compare the first road quality indicator to a first road quality indicator threshold value that establishes first road quality indicator limits and the second road quality indicator to a second road quality indicator threshold value that establishes second road quality indicator limits for each of the location coordinates on the haul road;
transmit via the communication module the location coordinates and the first road quality indicator to the vehicles in response to determining that the first road quality indicator at one of the location coordinates is outside the first road quality indicator limits; and
transmit via the communication module the location coordinates and the second road quality indicator to the vehicles in response to determining that the second road quality indicator at one of the location coordinates is outside the second road quality indicator limits.

5. The vehicle of claim 4, wherein the ECM is programmed to:
transmit via the communication module the road maintenance request message in response to determining from the road quality indicator log that multiple of the vehicles have determined that the first road quality indicator for the one of the location coordinates are outside of the first road quality indicator limits; and
transmit via the communication module the road maintenance request message in response to determining from the road quality indicator log that multiple of the vehicles have determined that the second road quality indicator for the one of the location coordinates are outside of the second road quality indicator limits.

6. The vehicle of claim 1, wherein the ECM is programmed to calculate the road quality indicators and compare the road quality indicators only in response to determining from the GPS signals that the vehicle is traveling on the haul road.

7. The vehicle of claim 1, wherein the ECM is programmed to transmit the road maintenance request message to a back office of the work site from the communication module via a wireless communication link.

8. The vehicle of claim 1, wherein the ECM is programmed to transmit the road maintenance request message by downloading the road maintenance request message to a peripheral device operatively connected to the communication module.

9. The vehicle of claim 1, wherein the ECM is programmed to transmit via the communication module a timestamp and a vehicle identifier with the location coordinates and the road quality indicator.

10. A system for determining haul road repair needs at locations on the haul road at the work site having multiple vehicles operating at the work site, the system comprising a plurality of the vehicles of claim 1, wherein the ECM of one of the vehicles is programmed to:
receive via the communication module the location coordinates and the road quality indicator from the other vehicles;
store the location coordinates and the road quality indicator from the other vehicles in the road quality indicator log in the memory; and
transmit via the communication module the road maintenance request message in response to determining from the road quality indicator log that multiple of the vehicles at the work site have determined that the road quality indicators for the one of the location coordinates are outside of the road quality indicator limits.

11. The system of claim 10, wherein the ECM of the one of the vehicles is programmed to transmit the road maintenance request message to a back office of the work site from the communication module via a wireless communication link.

12. A method for determining haul road repair needs at location coordinates on a haul road at a work site having vehicles operating at the work site, the method comprising:
at each of the vehicles, gathering operational data at the location coordinates on the haul road as the vehicles are operated at the work site and drive along the haul road;
at each of the vehicles, calculating a road quality indicator for each of the location coordinates on the haul road;
at each of the vehicles, comparing the road quality indicator for each of the location coordinates on the haul road to a road quality indicator threshold value that establishes road quality indicator limits;
at each of the vehicles, transmitting the location coordinates and the road quality indicator to the vehicles in response to determining that the road quality indicator at one of the location coordinates is outside the road quality indicator limits;
at one of the vehicles, receiving the location coordinates and the road quality indicator for the one of the location coordinates from the vehicles and storing the location coordinates and the road quality indicator in a road quality indicator log; and
at the one of the vehicles, transmitting a road maintenance request message in response to determining that multiple of the vehicles have determined that road quality indicators for the one of the location coordinates are outside of the road quality indicator limits.

13. The method of claim 12, wherein transmitting the location coordinates and the road quality indicator comprises transmitting the location coordinates and the road quality indicator via a wireless communication link.

14. The method of claim 12, wherein transmitting the road maintenance request message comprises transmitting the road maintenance request message in response to determining that one of the vehicles has determined more than two times that the road quality indicators for the one of the location coordinates are outside of the road quality indicator limits.

15. The method of claim 12, wherein the road quality indicator comprises a first road quality indicator and a second road quality indicator, wherein calculating the road quality indicator comprises calculating the first road quality indicator and the second road quality indicator for each of the location coordinates on the haul road, wherein comparing the road quality indicator comprises comparing the first road quality indicator to a first road quality indicator threshold value that establishes first road quality indicator limits and the second road quality indicator to a second road quality indicator threshold value that establishes second road quality indicator limits for each of the location coordinates on the haul road, and wherein transmitting the location coordinates and the road quality indicator comprises transmitting the location coordinates and the first road quality indicator to the vehicles in response to determining that the first road quality indicator at one of the location coordinates is outside the first road quality indicator limits and transmitting the location coordinates and the second road quality indicator to the vehicles in response to determining that the second road quality indicator at one of the location coordinates is outside the second road quality indicator limits.

16. The method of claim 15, wherein transmitting the road maintenance request message comprises transmitting the road maintenance request message in response to determining that multiple of the vehicles have determined that first road quality indicators for the one of the location coordinates are outside of the first road quality indicator limits and transmitting the road maintenance request message in response to determining that multiple of the vehicles have determined that second road quality indicator for the one of the location coordinates are outside of the second road quality indicator limits.

17. The method of claim 12, comprising, at each of the vehicles, performing the gathering, calculating and comparing steps only in response to determining that the one of the vehicles is traveling on the haul road.

18. The method of claim 12, wherein transmitting the road maintenance request message comprises transmitting the road maintenance request message to a back office of the work site via a wireless communication link.

19. The method of claim 12, wherein transmitting the road maintenance request message comprises downloading the road maintenance request message to a peripheral device operatively connected to one of the vehicles.

20. The method of claim 12, wherein transmitting the location coordinates and the road quality indicator comprises transmitting the location coordinates, the road quality indicator, a timestamp and a vehicle identifier.
